(19) United States
(12) Patent Application Publication
(10) Pub. No.: US 2015/0033244 A1
(43) Pub. Date: Jan. 29, 2015

(54) Actuator, Optical Pickup, and Disc Apparatus

(71) Applicant: Funai Electric Co., Ltd., Osaka (JP)

(72) Inventors: Ryozo Hosoda, Osaka (JP); Tatsuya Ito, Osaka (JP); Togo Kojima, Osaka (JP); Shinya Hatano, Osaka (JP); Kenji Tanehashi, Osaka (JP)

(73) Assignee: Funai Electric Co., Ltd., Osaka (JP)

(21) Appl. No.: 14/336,033

(22) Filed: Jul. 21, 2014

(30) Foreign Application Priority Data
Jul. 24, 2013 (JP) 2013-153410

(51) Int. Cl. G11B 7/09; G02B 7/04

(52) U.S. Cl. CPC G11B 7/0935; G02B 7/04
USPC 720/663; 359/824

(57) ABSTRACT

Provided is an actuator, an optical pickup, and a disc apparatus, with improved assembling workability and reduced manufacturing cost. The actuator of the optical pickup of the disc apparatus includes a movable part and a fixed part supporting the movable part in a movable manner. The movable part includes a case and a plurality of drive substrates having the same specification. The drive substrates are disposed at positions opposed to each other with respect to the case. Each drive substrate includes a winding member for driving the movable part and a wiring pattern for supplying current to the winding member. The wiring pattern includes a plurality of electrodes and a conductive path. The electrodes are disposed at positions opposed to each other with respect to the winding member. The conductive path is branched from one end of the winding member and is connected to the electrodes.

This application is based on Japanese Patent Application No. 2013-153410 filed on Jul. 24, 2013, contents of which are hereby incorporated by reference.

### BACKGROUND OF THE INVENTION

1. Field of the Invention

The present invention relates to a disc apparatus including an optical pickup that drives an objective lens by an actuator.

2. Description of Related Art

As disc recording media for recording images, sounds, or information, there are known compact discs (CDs), digital versatile discs (DVDs), Blu-ray (registered trademark) discs (BD), and the like. In a disc apparatus for recording or reproducing information on the disc recording medium, an optical pickup emits a laser beam to irradiate an information recording surface of the disc recording medium so as to record information. In addition, the optical pickup detects the laser beam reflected by the information recording surface of the disc recording medium so as to read information. In this case, the optical pickup adjusts a position of an objective lens by an actuator so as to perform tracking control, focus control, and the like.

For instance, the actuator described in JP-A-2010-257520 includes a pair of print coil substrates equipped with a tracking control coil and a focus control coil, which are attached to both side faces of the lens holder of the objective lens. This lens holder is supported by a fixed part via a suspension in a movable manner. This suspension is a wire-like elastic member formed integrally with the lens holder by insert molding, and one end thereof is connected to the fixed part.

However, when the suspension is formed integrally with the lens holder by insert molding as described in JP-A-2010-257520, cost of the mold is increased. In addition, when reworking the apparatus, workability is not good because the actuator can hardly be repaired, or a component thereof can hardly be exchanged. Therefore, there is a problem that the actuator is usually replaced with a new one so that component loss is large in reworking.

### SUMMARY OF THE INVENTION

The present invention is made in view of the above-mentioned problem, and it is an object of the present invention to provide an actuator, an optical pickup, and a disc apparatus, which can improve workability in assembly and can reduce manufacturing cost.

In order to achieve the above-mentioned object, an actuator according to an embodiment of the present invention includes a movable part, and a fixed part for supporting the movable part in a movable manner. The movable part includes a case and a plurality of drive substrates having the same specification. The plurality of drive substrates are disposed at positions opposed to each other with respect to the case. Each of the drive substrates includes a winding member for driving the movable part and a wiring pattern for supplying current to the winding member. The wiring pattern includes a plurality of electrodes and a conductive path. The plurality of electrodes are disposed at positions opposed to each other with respect to the winding member. The conductive path is branched from one end of the winding member and is connected to the plurality of electrodes.

Further features and advantages of the present invention will become more apparent from the embodiments described below.

### BRIEF DESCRIPTION OF THE DRAWINGS

FIG. 1 is a perspective view of a BD recorder including an optical disk apparatus according to this embodiment.

FIG. 2A is a top view of the optical disk apparatus according to this embodiment.

FIG. 2B is a top view illustrating an internal structure of the optical disk apparatus according to this embodiment.

FIG. 3 is a perspective view illustrating a lens actuator according to this embodiment.

FIG. 4 is a perspective view of a movable part.

FIG. 5 is an exploded perspective view illustrating a structure of the movable part.

FIG. 6 is a local perspective view illustrating an example of a wire stopper disposed to protrude in vicinity of an end of a suspension wire.

FIG. 7 is a top view of a lens holder to which a print coil substrate is attached.

FIG. 8 is a cross-sectional view illustrating a shape of a groove.

FIG. 9 is a side view of the lens holder to which the print coil substrate is attached, viewed from front.

FIG. 10 is a diagram illustrating a magnetizing pattern of the print coil substrate attached to the front side of the lens holder.

FIG. 11 is an exploded perspective view illustrating a structure of the print coil substrate.

FIG. 12 is a diagram illustrating a wiring structure of the print coil substrate.

### DETAILED DESCRIPTION OF THE PREFERRED EMBODIMENTS

Now, an embodiment of the present invention is described with reference to the drawings, in which an optical disk apparatus 1 is exemplified. Note that the optical disk apparatus 1 is an example of a disc apparatus of the present invention.

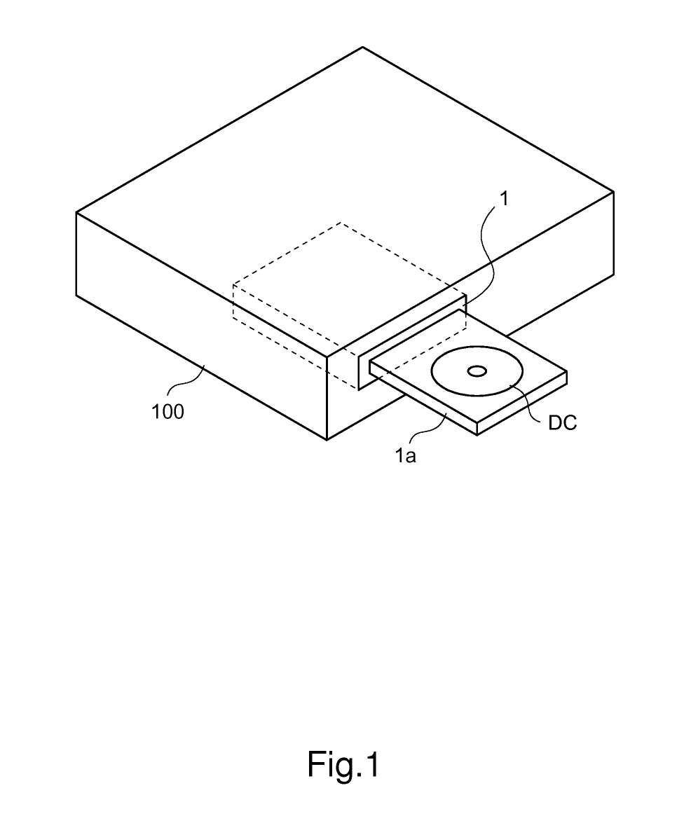

FIG. 1 is a perspective view of a BD recorder equipped with the optical disk apparatus according to this embodiment. As illustrated in FIG. 1, the optical disk apparatus 1 is mounted in a BD recorder 100, loads an optical disk DC placed on a disc tray 1a to the inside, and reads information from the optical disk DC. The optical disk DC is an optical disk storage medium such as a compact disc (CD), a digital versatile disc (DVD), a Blu-ray disc (BD, registered trademark) and the like.

<Structure of Optical Disk Apparatus>

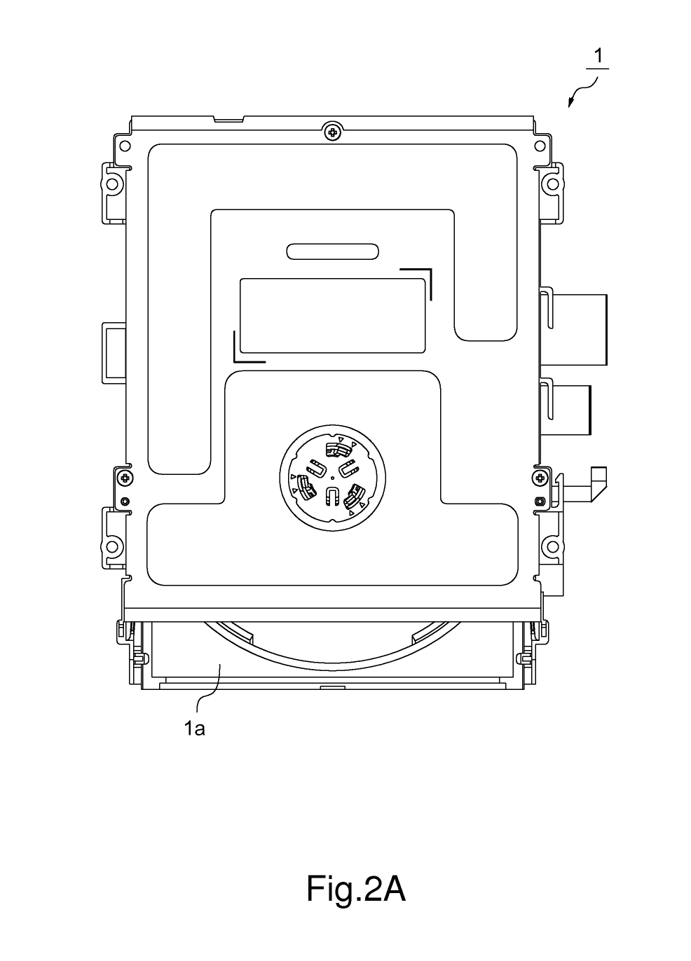

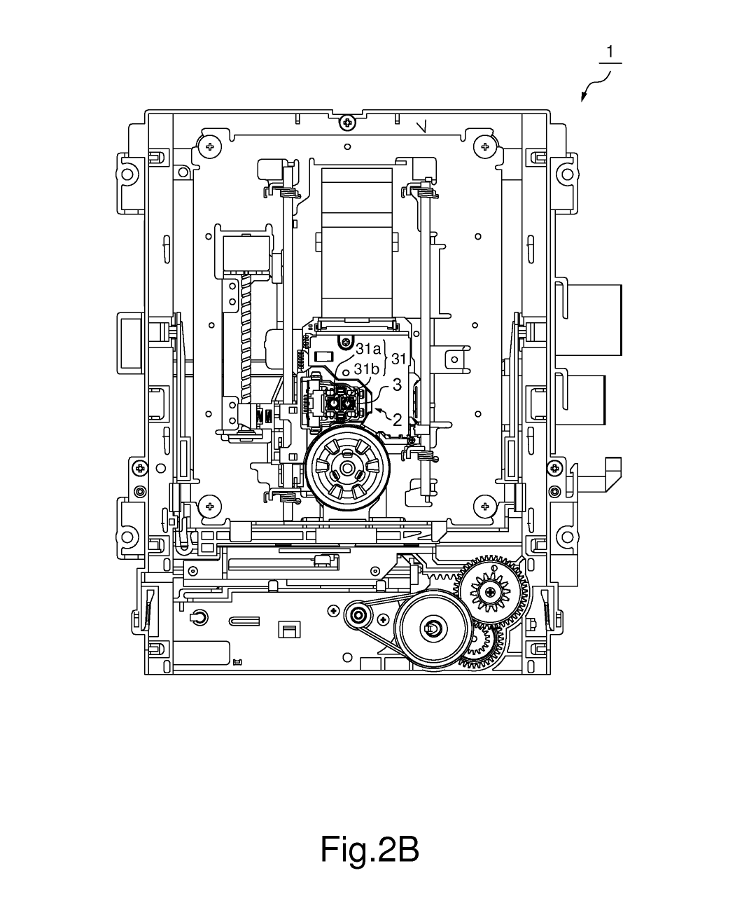

FIG. 2A is a top view of the optical disk apparatus according to this embodiment. FIG. 2B is a top view illustrating an internal structure of the optical disk apparatus according to this embodiment. As illustrated in FIG. 2A and FIG. 2B, the optical disk apparatus 1 includes the above-mentioned disc tray 1a and an optical pickup 2.

The optical pickup 2 includes a laser diode (not shown), an optical system (not shown) including an objective lens 31, a photodiode (not shown), and a lens actuator 3.

The laser diode is a semiconductor laser element that emits a laser beam. For instance, the laser diode includes a first laser diode (not shown) emitting a laser beam for DVD having a wavelength of 661 nm, and a second laser diode (not shown) emitting a laser beam for BD having a wavelength of 405 am. The optical system is constituted of optical elements (including the objective lens 31) for guiding the laser beam output from the laser diode to the optical disk DC. The laser beam passing through the optical system is condensed to an information recording surface of the optical disk DC by the objective lens 31. Thus, a light spot of the laser beam is formed on the optical disk DC. The condensed laser beam is reflected by the information recording surface and is guided to the photodiode after passing through the optical system. The photodiode receives the laser beam reflected by the optical disk DC (reflection light) and performs photoelectric conversion so as to generate an electric signal corresponding to intensity of the received reflection light. This electric signal indicates intensity of the reflection light and includes information recorded on the optical disk DC.

In addition, the lens actuator 3 is disposed between the optical system and the optical disk DC. The lens actuator 3 includes two objective lenses 31 (for example, a DVD lens 31a and a BD lens 31b described later) and is capable of adjusting positions of the objective lenses 31.

<Structure of Lens Actuator>

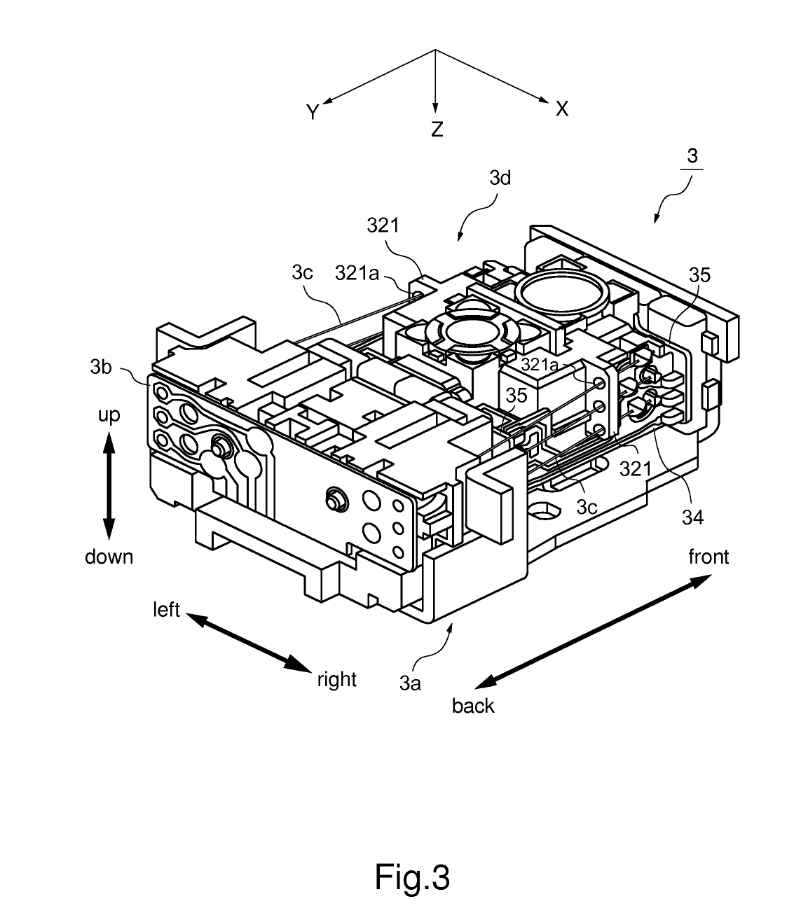

Next, a specific structure of the lens actuator 3 is described. FIG. 3 is a perspective view illustrating a lens actuator according to this embodiment.

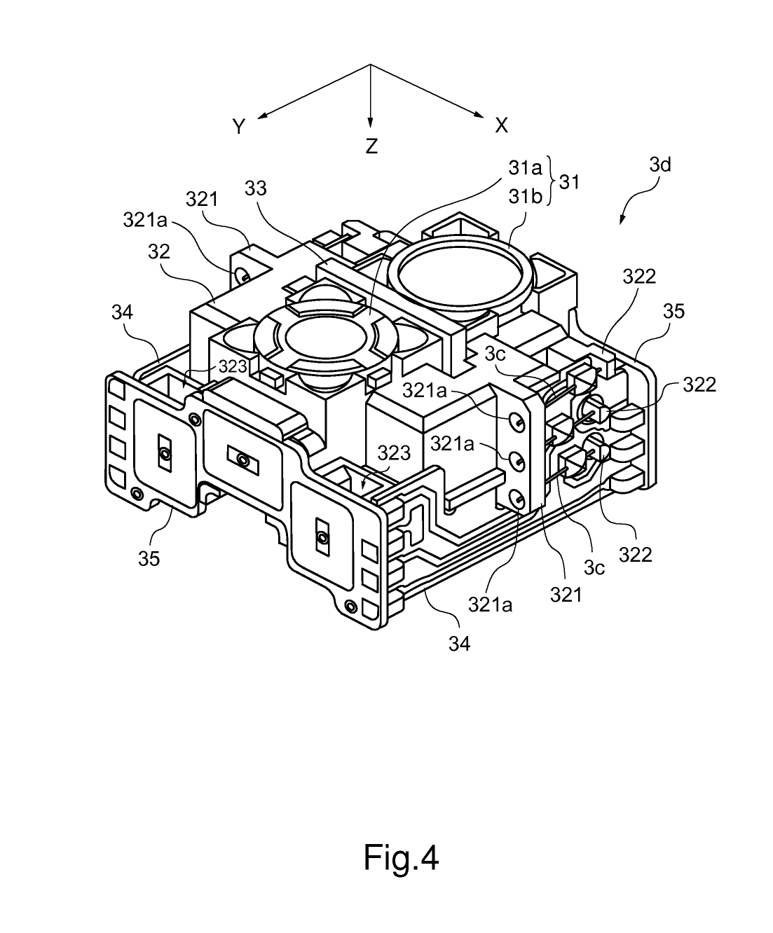

Note that in FIG. 3, an X direction corresponds to a radial direction of the optical disk DC, and a Y direction corresponds to a tangential direction of the optical disk DC. In addition, a Z direction is substantially parallel to the vertical direction. The X direction, the Y direction, and the Z direction are orthogonal to each other. In addition, in the following description, one side in the X direction (for example, the direction toward the lower right in FIG. 3) is referred to as right and the other side in the X direction (for example, the direction toward the upper left in FIG. 3) is referred to as left. In addition, one side in the Y direction (for example, the direction toward the upper right in FIG. 3) is referred to as front, and the other side in the Y direction (for example, the direction toward the lower left in FIG. 3) is referred to as rear. In addition, one side in the Z direction (for example, the direction facing upward in FIG. 3) is referred to as upper side, and the other side in the Z direction (for example, the direction facing downward in FIG. 3) is referred to as lower side. This direction relationship is also applied to FIGS. 4 to 11 referred to later in the same manner.

As illustrated in FIG. 3, the lens actuator 3 includes a fixed part 3a, a print substrate 3b, suspension wires 3c, and a movable part 3d.

The fixed part 3a supports the movable part 3d in a movable manner and includes a magnet or the like for moving the movable part 3d. The print substrate 3b is a control circuit supplied with a signal (for example, a control signal) from a controller (not shown) for controlling the entire optical pickup 2 so as to drive and control the lens actuator 3. The print substrate 3b is attached to a rear side face of the fixed part 3a with adhesive, soldering, screws, or the like.

The suspension wire 3c is a wire-like power supply member that supports the movable part 3d, and a plurality of suspension wires 3c are disposed on the left and right sides in the X direction of the lens actuator 3. One end of each suspension wire 3c is fixed to the fixed part 3a. In addition, the other end thereof is soldered to a relay substrate 34 described later of the movable part 3d through an accuracy hole 321a of a wire supporter 321 described later. In addition, the suspension wire 3c is formed using a conductive material such as metal material so as to supply electric power from a power supply part (not shown) disposed in the fixed part 3a to the movable part 3d. Note that this electric power is supplied to a print coil substrate 35 of the movable part 3d described later via the relay substrate 34.

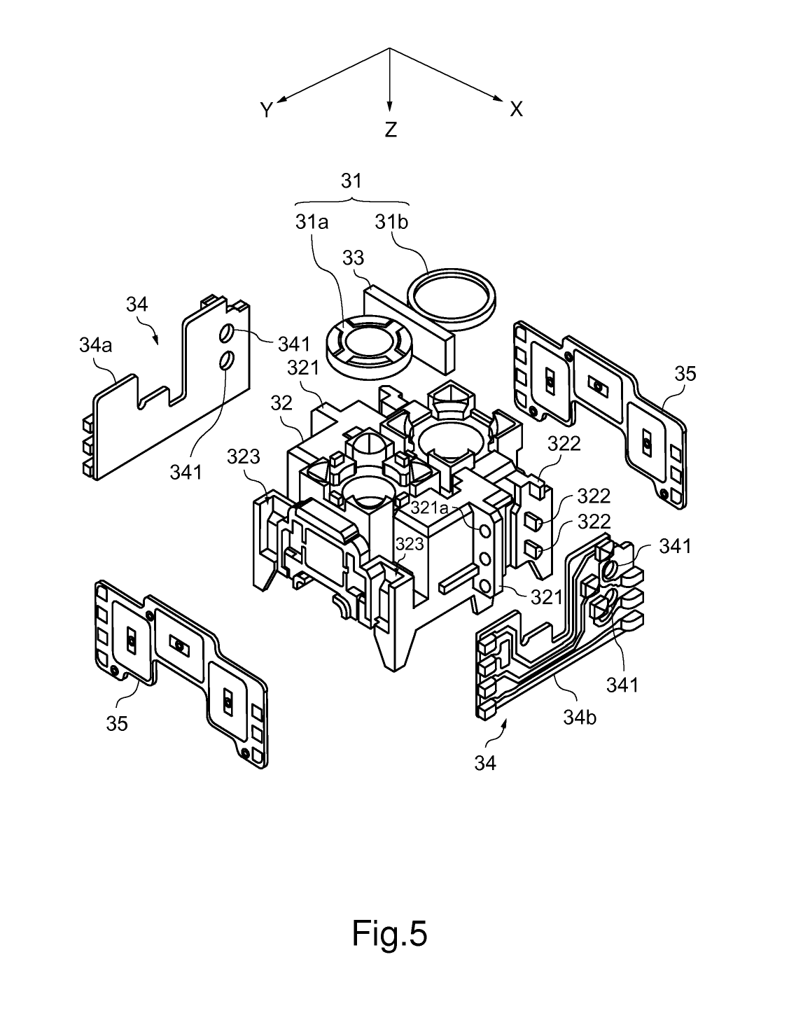

Next, a structure of the movable part 3d is described. FIG. 4 is a perspective view of the movable part. Note that in FIG. 4, a part of the suspension wire 3c is not illustrated for easy understanding of the structure of the movable part 3d. In addition, FIG. 5 is an exploded perspective view for explaining the structure of the movable part. As illustrated in FIG. 4 and FIG. 5, the movable part 3d includes the two objective lenses 31, a lens holder 32, a lens protector 33, a pair of the relay substrates 34, and a pair of the print coil substrates 35 (drive substrates).

The lens holder 32 is a case that is used as a holding member of the two objective lenses 31. The objective lenses 31 include the DVD lens 31a and BD lens 31b, for example, which are disposed side by side in the Y direction. In addition, the lens protector 33 is disposed between the two objective lenses 31.

On both side faces in the X direction of the lens holder 32, there are disposed the pair of relay substrates 34 by means of adhesive, soldering, screws, or the like, for example. The pair of relay substrates 34 have symmetric shapes (plane-symmetric shapes) in the left and right direction and are made of the same resin. The relay substrates 34 have different conductive patterns formed on principal planes of the resin substrates made of resin material such as PCB. The conductive pattern includes electrodes to which end parts or vicinities thereof of the suspension wire 3c are electrically connected using solder, electrodes electrically connected to the pair of print coil substrates 35, and conductive paths electrically connecting between the electrodes. The pair of print coil substrates 35 are electrically connected via the conductive pattern of each relay substrate 34, and the electric power is supplied from the suspension wire 3c to the pair of print coil substrates 35. In addition, in the relay substrate 34, there are formed openings 341 in which wire stoppers 322 described later are inserted.

In addition, the wire supporter 321 and the wire stoppers 322 are disposed to protrude on both side faces in the X direction of the lens holder 32. In the wire supporter 321, there are formed the accuracy holes 321a for accurately restricting an attachment position of the suspension wire 3c to the movable part 3d (in particular, the relay substrate 34). The suspension wire 3c is made to pass through the accuracy hole 321a, and hence it is possible to suppress a shift of the attachment position when the suspension wire 3c is attached to a predetermined position of the relay substrate 34.

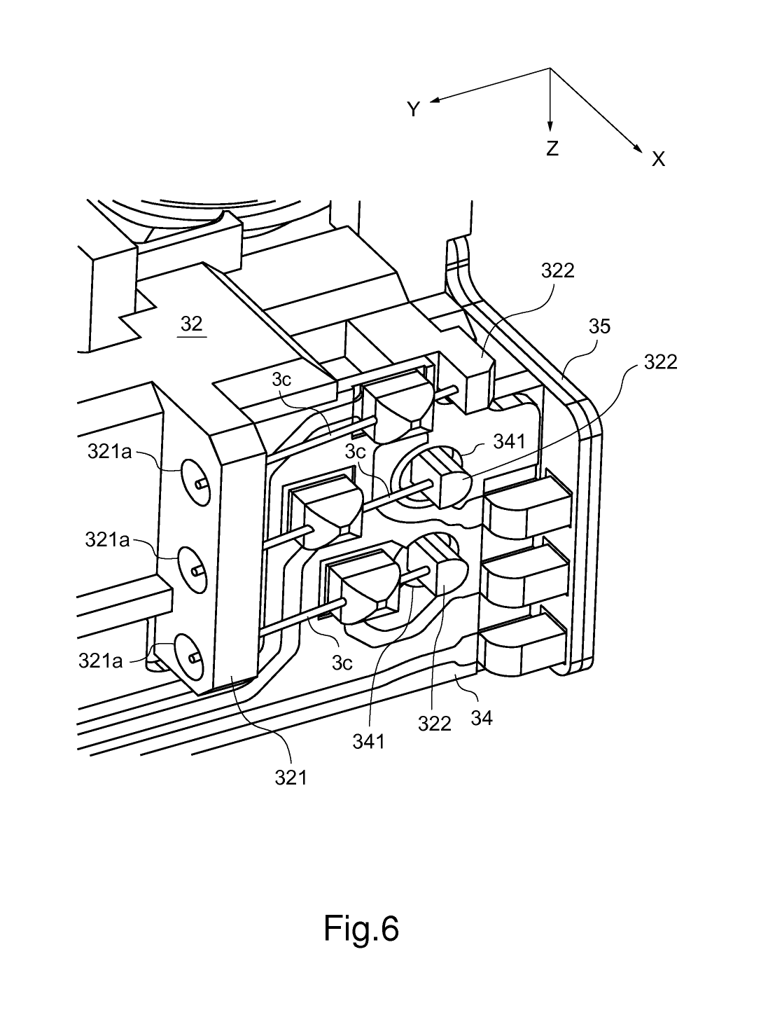

The wire stopper 322 is a contact prevention member for preventing the end part of the suspension wire 3c from contacting with the print coil substrate 35, and is disposed to protrude in a vicinity of a distal end of the end part of the suspension wire 3c. FIG. 6 is a local perspective view illustrating an example of the wire stopper disposed to protrude in a vicinity of the end part of the suspension wire. As illustrated in FIG. 6, a part of the wire stopper 322 protrudes to the outside of the side face in the X direction of the lens holder 32 from the relay substrate 34 through the opening 341 formed in the relay substrate 34. In this way, the wire stopper 322 can be disposed to protrude in the vicinity of the end part of the suspension wire 3c without being interfered by the relay substrate 34. Therefore, when the suspension wire 3c is attached, it is possible to prevent the suspension wire 3c from contacting with the print coil substrate 35 to make a short circuit. Therefore, it is possible to prevent solder short in an assembly process of the lens actuator 3 (in particular, in a soldering step of the suspension wire 3c). Further, because the wire stopper 322 is inserted in the opening 341 of the relay substrate 34, the relay substrate 34 can be correctly positioned when the relay substrate 34 is attached to the lens holder 32.

In addition, the pair of print coil substrates 35 are disposed on both side faces (both end surfaces) in the Y direction (predetermined direction) of the lens holder 32 using UV hardener 324, for example (see FIG. 4). The UV hardener 324 is adhesive that is cured by irradiation with ultraviolet rays. By using the UV hardener 324 that is cured by irradiation with ultraviolet rays, the print coil substrate 35 can be easily fixed to the lens holder 32.

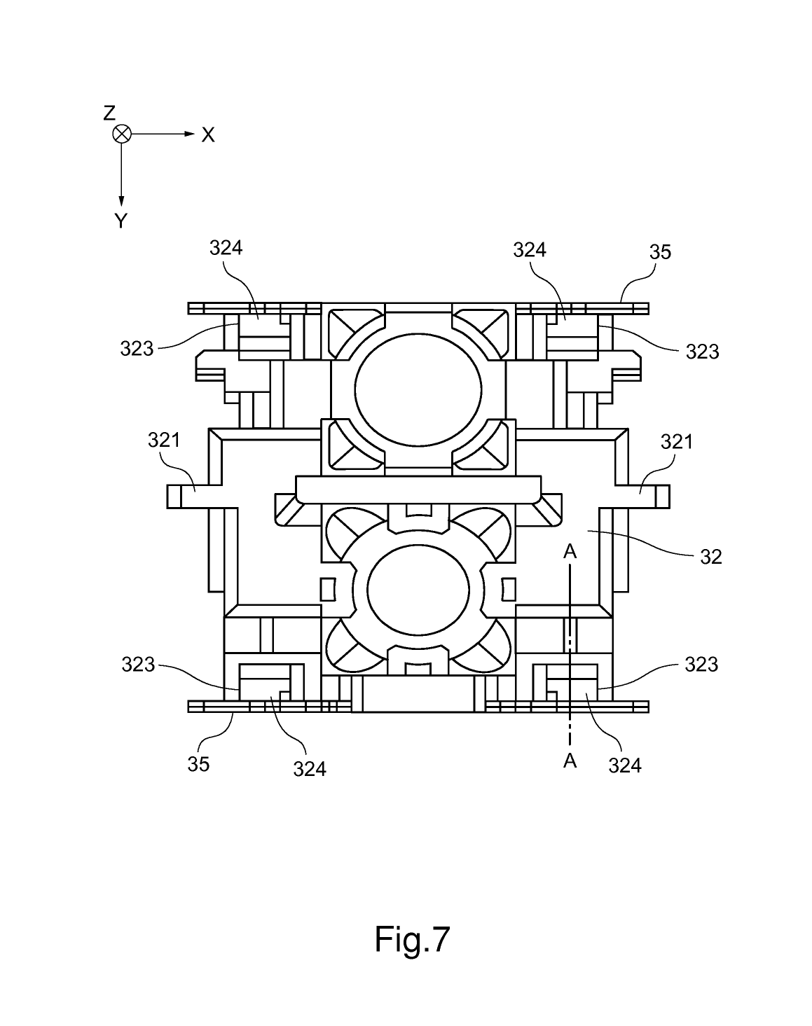

FIG. 7 is a top view of the lens holder equipped with the print coil substrates. As illustrated in FIG. 7, two grooves 323 are formed on each side face (each end surface) in the Y direction of the lens holder 32. These grooves 323 are recesses in which the UV hardener 324 is filled for fixing the print coil substrate 35 to the lens holder 32 and are formed in vicinities of the both ends in the X direction of the front side and the rear side of the lens holder 32.

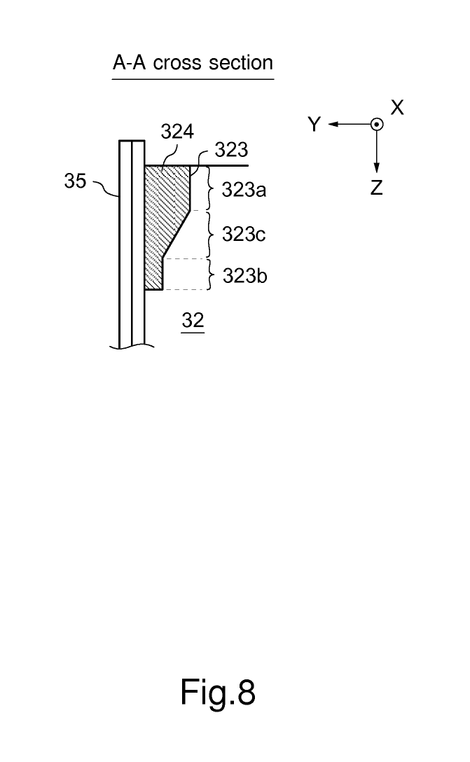

FIG. 8 is a cross-sectional view for explaining a shape of the groove. Note that FIG. 8 illustrates a cross section of the groove 323 taken along the dot-dashed line A-A in FIG. 7. As illustrated in FIG. 8, the groove 323 opens on the end surface (side face) in the Y direction of the lens holder 32 and on an adjacent surface of the end surface (upper face in the Z direction). In addition, the groove 323 includes first and second flat parts 323a and 323b and an inclined part 323c disposed between the first and second flat parts 323a and 323b. The first and second flat parts 323a and 323b have inner walls substantially parallel to the X direction and the Z direction. In addition, in the Y direction, a depth of the first flat part 323a (distance between the end surface of the lens holder 32 and the inner wall) is larger than a depth of the second flat part 323b. In addition, the inclined part 323c has an inner wall inclined to the upper face of the lens holder 32 and the inner walls of the first and second flat parts 323a and 323b. The inner wall of the inclined part 323c is continuously connected to the inner walls of the first and second flat parts 323a and 323b.

Because the groove 323 has the inclined part 323c as illustrated in FIG. 8, when pouring the UV hardener 324 into the groove 323 from the upper face side in the state where the principal plane of the print coil substrate 35 is contacted with the side face in the Y direction of the lens holder 32, the UV hardener 324 can be easily filled in the groove 323 to the lower end without a gap.

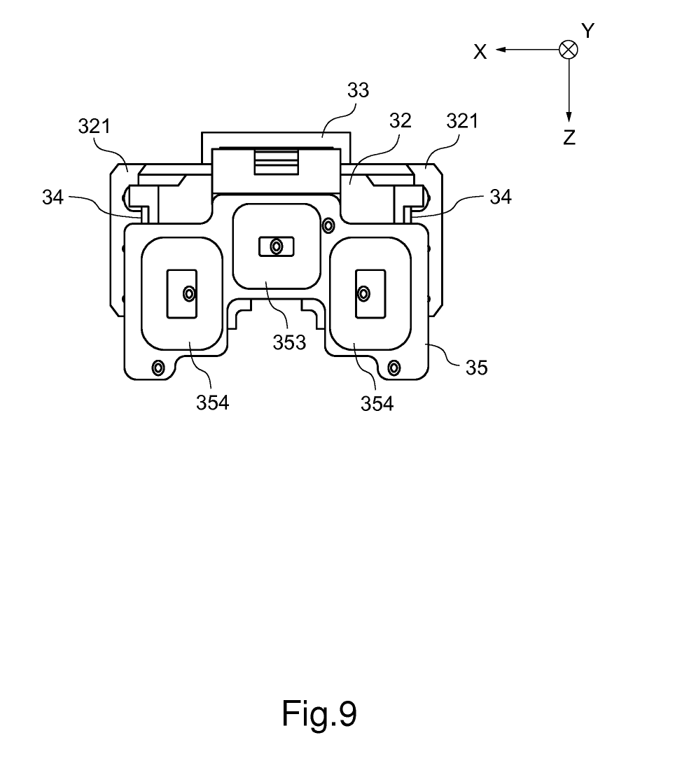

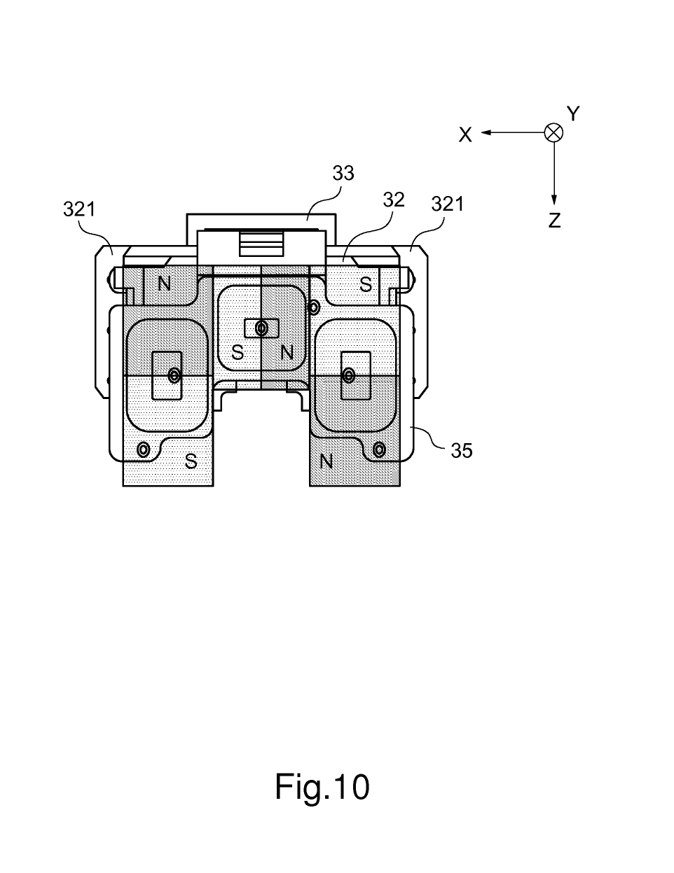

Next, the print coil substrate 35 is described. FIG. 9 is a side view of the lens holder equipped with the print coil substrates viewed from the front side. In addition, FIG. 10 is a diagram illustrating a magnetizing pattern of the print coil substrate attached to the front side of the lens holder. The pair of print coil substrates 35 have the same specification (for example, structure, material, shape, and wiring pattern). In addition, each print coil substrate 35 includes one tracking control coil 353 and two focus control coils 354 disposed on both sides of the tracking control coil 353. The tracking control coil 353 is a coil member for performing tracking control, and the focus control coil 354 is a coil member for performing focus control. These coil members 353 and 354 (winding members) are driven by electric power supplied from the relay substrate 34 and have the magnetizing pattern as illustrated in FIG. 10, for example.

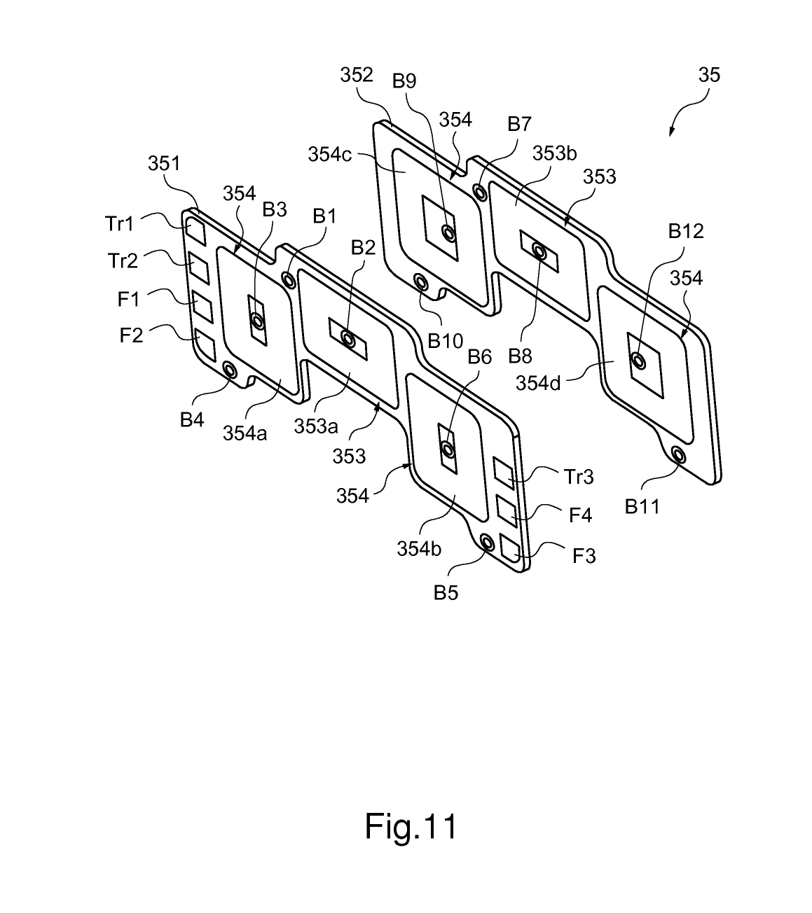

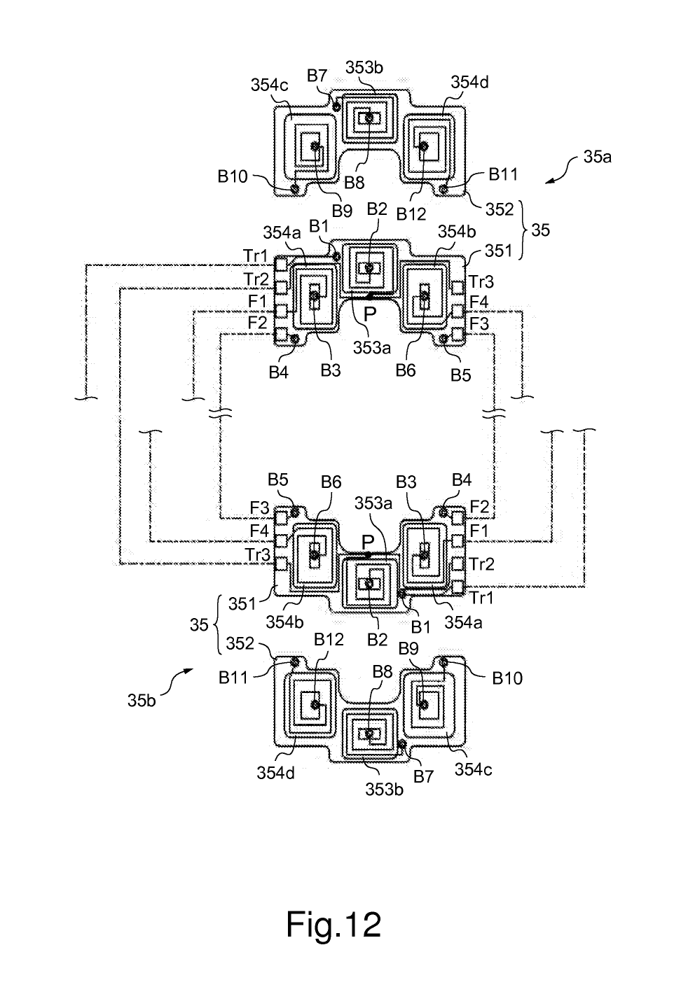

FIG. 11 is an exploded perspective view for explaining a structure of the print coil substrates. In addition, FIG. 12 is a diagram illustrating a wiring structure of the print coil substrates. Each print coil substrate 35 includes first and second coil substrates 351 and 352 that are glued to each other using adhesive or the like as illustrated in FIG. 11. Note that the coil substrate constituting each print coil substrate 35 is not limited to the example illustrated in FIG. 11 and may be a single substrate, but it is preferred to be a plurality of substrates (for example, two to four substrates). When the print coil substrate 35 is constituted of a plurality of coil substrates, sensitivity of the print coil substrate 35 is improved so that the lens actuator 3 can be driven with high accuracy.

In each print coil substrate 35, as illustrated in FIG. 11 and FIG. 12, the first coil substrate 351 includes a first tracking coil pattern 353a, first and second focus coil patterns 354a and 354b, via holes B1 to B6, and a wiring pattern formed on a resin substrate. Note that the resin substrate is formed of a resin material such as PCB. In addition, the wiring pattern of the first coil substrate 351 includes first to third tracking electrodes Tr1 to Tr3, first to fourth focus electrodes F1 to F4, and conductive paths formed inside the via holes B1 to B6.

In addition, the second coil substrate 352 includes a second tracking coil pattern 353b, third and fourth focus coil patterns 354c and 354d, via holes B7 to B12, and a wiring pattern formed on a resin substrate. Note that the resin substrate is formed of a resin material such as PCB. In addition, the wiring pattern of the second coil substrate 352 includes conductive paths formed inside the via holes B7 to B12.

Resin substrates having the same shape and the same material are used for the first and second coil substrates 351 and 352. In addition, in each print coil substrate 35, the first and second tracking coil patterns 353a and 353b constitute the tracking control coil 353. In addition, the first and third focus coil patterns 354a and 354c constitute one of the two focus control coils 354. In addition, the second and fourth focus coil patterns 354b and 354d constitute the other of the two focus control coils 354. Note that in FIG. 11 and FIG. 12, the first and second tracking coil patterns 353a and 353b and the first to fourth focus coil patterns 354a to 354d are coil members formed of coil-like flat wiring pattern. These coil members are not limited to those illustrated in FIG. 11 and FIG. 12, and may be coil elements formed of a spiral conductive wire.

In addition, as illustrated in FIG. 12, in each print coil substrate 35, the first tracking electrode Tr1 is electrically connected to one end of the second tracking coil pattern 353b via the wiring pattern including the via holes B1 and B7. The other end of the second tracking coil pattern 353b is electrically connected to one end of the first tracking coil pattern 353a via the wiring pattern including the via holes B8 and B2. The other end of the first tracking coil pattern 353a is electrically connected to the second and third tracking electrodes Tr2 and Tr3 via the wiring pattern branching into two paths at a branch point P.

In addition, in each print coil substrate 35, the first focus electrode F1 is electrically connected to one end of the first focus coil pattern 354a. The other end of the first focus coil pattern 354a is electrically connected to one end of the third focus coil pattern 354c via the wiring pattern including the via holes B3 and B9. The other end of the third focus coil pattern 354c is electrically connected to the second focus electrode F2 via the wiring pattern including the via holes B10 and B4.

In addition, in each print coil substrate 35, the third focus electrode F3 is electrically connected to one end of the fourth focus coil pattern 354d via the wiring pattern including the via holes B5 and B11. The other end of the fourth focus coil pattern 354d is electrically connected to one end of the second focus coil pattern 354b via the wiring pattern including the via holes B12 and B6. The other end of the second focus coil pattern 354b is electrically connected to the fourth focus electrode F4.

Next, the wiring structure between the print coil substrates 35 is described with reference to FIG. 12. First, a wiring structure for driving the tracking control coil 353 of each print coil substrate 35 is described. Note that in the following description, the print coil substrate 35 disposed on the front side of the lens holder 32 is referred to as a first print coil substrate 35a, and the print coil substrate 35 disposed on the rear side is referred to as a second print coil substrate 35b. In addition, the relay substrate 34 disposed on the left side of the lens holder 32 is referred to as a first relay substrate 34a, and the relay substrate 34 disposed on the right side thereof is referred to as a second relay substrate 34b (see FIG. 5).

The first tracking electrode Tr1 of the first print coil substrate 35a is electrically connected to the suspension wire 3c via the conductive pattern of the first relay substrate 34a. The second tracking electrode Tr2 of the first print coil substrate 35a is electrically connected to the third tracking electrode Tr3 of the second print coil substrate 35b via the conductive pattern of the first relay substrate 34a. The first tracking electrode Tr1 of the second print coil substrate 35b is electrically connected to the suspension wire 3c via the conductive pattern of the second relay substrate 34b on the right side of the lens holder 32. With this wiring structure, the tracking control coil 353 of each print coil substrate 35 can be driven by electric power supplied from the power supply part (not shown) via the suspension wire 3c and the relay substrate 34.

Next, a wiring structure for driving the focus control coil 354 of each print coil substrate 35 is described. The first focus electrode F1 of the first print coil substrate 35a is electrically connected to the suspension wire 3c via the conductive pattern of the first relay substrate 34a. The second focus electrode F2 of the first print coil substrate 35a is electrically connected to the third focus electrode F3 of the second print coil substrate 35b via the conductive pattern of the first relay substrate 34a. The fourth focus electrode F4 of the second print coil substrate 35b is electrically connected to the suspension wire 3c via the conductive pattern of the first relay substrate 34a. With this wiring structure, one of the two focus control coils 354 of each print coil substrate 35 (the focus control coil 354 constituted of the first and third focus coil patterns 354a and 354c of the first print coil substrate 35a, and the focus control coil 354 constituted of the second and fourth focus coil patterns 354b and 354d of the second print coil substrate 35b) is driven by the electric power supplied from the power supply part (not shown) via the suspension wire 3c and the relay substrate 34.

In addition, the first focus electrode F1 of the second print coil substrate 35b is electrically connected to the suspension wire 3c via the conductive pattern of the second relay substrate 34b on the right side of the lens holder 32. The second focus electrode F2 of the second print coil substrate 35b is electrically connected to the third focus electrode F3 of the first print coil substrate 35a via the conductive pattern of the second relay substrate 34b. The fourth focus electrode F4 of the first print coil substrate 35a is electrically connected to the suspension wire 3c via the conductive pattern of the second relay substrate 34b. With this wiring structure, the other of the two focus control coils 354 of each print coil substrate 35 (the focus control coil 354 constituted of the second and fourth focus coil patterns 354b and 354d of the first print coil substrate 35a, and the focus control coil 354 constituted of the first and third focus coil patterns 354a and 354c of the second print coil substrate 35b) is driven by the electric power supplied from the power supply part (not shown) via the suspension wire 3c and the relay substrate 34.

In this way, the lens actuator 3 of the optical pickup 2 of the optical disk apparatus 1 according to this embodiment includes the movable part 3d, and the fixed part 3a for supporting the movable part 3d in a movable manner. The movable part 3d includes the lens holder 32 and the plurality of print coil substrates 35 having the same specification disposed at positions opposed to each other with respect to the lens holder 32. Each print coil substrate 35 includes the coil member for driving the movable part 3d and the wiring pattern for supplying current (electric power) to the coil member. (Note that the coil member is, for example, the tracking control coil 353 constituted of the first and second tracking coil patterns 353a and 353b, and the two focus control coils 354 constituted of the first to fourth focus coil patterns 354a to 354d.) The wiring pattern includes the plurality of tracking electrodes Tr2 and Tr3 disposed at positions opposed to each other with respect to the first tracking coil pattern 353a, and the conductive path branched from one end of the first tracking coil pattern 353a so as to be connected to the plurality of tracking electrodes Tr2 and Tr3.

In this way, the plurality of print coil substrates 35 are provided to the movable part 3d supported by the fixed part 3a in a movable manner. In addition, in each print coil substrate 35, the conductive path is branched from one end of the first tracking coil pattern 353a and is connected to the plurality of tracking electrodes Tr2 and Tr3 that are disposed at positions opposed to each other with respect to the first tracking coil pattern 353a. Therefore, the plurality of print coil substrates 35 can have the same specification. Therefore, the structure becomes simple so that assembling workability can be improved. In addition, in reworking (for example, in reusing a member), because the members can be exchanged, it is possible to reduce loss of components. Therefore, it is possible to improve assembling workability and to reduce manufacturing cost.

In addition, the lens actuator 3 of this embodiment further includes the suspension wire 3c for supplying electric power to the movable part 3d. The lens holder 32 is provided with the relay substrate 34 for electrically connecting between the print coil substrates 35, and the wire stopper 322 for preventing the suspension wire 3c from contacting with the print coil substrate 35. In addition, at least a part of the wire stopper 322 protrudes through the opening 341 formed in the relay substrate 34 to the outside of the side face from the relay substrate 34.

In this way, the wire stopper 322 can be disposed to protrude in a vicinity of the suspension wire 3c without being interfered by the relay substrate 34. Therefore, when the suspension wire 3c is attached, it is possible to prevent the suspension wire 3c from contacting with the print coil substrate 35 to make a short circuit. Further, because the wire stopper 322 is inserted in the opening 341 of the relay substrate 34, when the relay substrate 34 is attached to the lens holder 32, the relay substrate 34 can be correctly positioned.

In addition, in the lens actuator 3 of this embodiment, the print coil substrate 35 is attached to the lens holder 32 using the UV hardener 324 that is cured by irradiation with ultraviolet rays. The lens holder 32 is provided with the groove 323 that opens on the attachment surface of the lens holder 32 to which the print coil substrate 35 is attached and on an adjacent surface of the attachment surface. The groove 323 includes the inclined part 323c including the inner wall inclined to the adjacent surface. The UV hardener 324 is filled in this groove 323.

With this structure, by using the UV hardener 324 that is cured by irradiation with ultraviolet rays, the print coil substrate 35 can be easily attached to the lens holder 32. In addition, because the groove 323 has the inclined part 323c, when the UV hardener 324 is poured into the groove 323, the UV hardener 324 can be easily filled in the groove 323 to the lower end without a gap.

In addition, in the lens actuator 3 of this embodiment, the movable part 3d further includes the pair of relay substrates 34 for electrically connecting between the print coil substrates 35, and the relay substrates 34 have shapes that are surface-symmetrical to each other and different conductive patterns.

With this structure, because the shapes of the pair of relay substrates 34 are surface-symmetrical to each other, a base having the same shape can be used for the relay substrates 34. Therefore, the manufacturing cost can be reduced.

As described above, the present invention is described with reference to the embodiment. Note that in the embodiment described above, there is exemplified the optical disk apparatus 1 for reading and writing information on the optical disk DC, but the application range of the present invention is not limited to this example. It is sufficient if the optical disk apparatus 1 is a disc apparatus that performs at least one of reading and writing of information on the disc recording medium. For instance, the optical disk apparatus 1 may be a disc apparatus that is mounted in a BD player, a DVD player, a DVD recorder, a personal computer, and the like.

In addition, in the embodiment described above, the optical disk apparatus 1 is mounted in the BD recorder 100, but the application range of the present invention is not limited to this example. The optical disk apparatus 1 may be electronic equipment for reproducing information recorded on the disc recording medium and/or recording information on the disc recording medium. For instance, the optical disk apparatus 1 may be a BD player, a DVD player, and a DVD recorder.

In addition, in the embodiment described above, the lens holder 32 includes two objective lenses 31, but the application range of the present invention is not limited to this example. It is sufficient if the lens holder 32 holds one or more objective lenses 31. In addition, each objective lens 31 may correspond to a structure of the laser diode of the optical pickup 2. In addition, the direction in which the plurality of objective lenses 31 are arranged is not particularly limited. For instance, in the embodiment described above, the plurality of objective lenses 31 may be arranged in the X direction.

In addition, in the embodiment described above, as illustrated in FIG. 3 for example, the pair of (namely two) print coil substrates 35 are disposed on both end surfaces in the Y direction of the lens holder 32, but the application range of the present invention is not limited to this example. A plurality of (for example, three or more of) the print coil substrates 35 may be disposed as long as they are disposed at least on both end surfaces in the Y direction of the lens holder 32. Further, in the embodiment described above, the pair of (namely two) relay substrates 34 are disposed on both end surfaces in the X direction of the lens holder 32, but the application range of the present invention is not limited to this example. A plurality of (for example, three or more of) the relay substrates 34 may be disposed in accordance with the number of the print coil substrates 35.

In addition, in the embodiment described above, the resin substrates (namely the bases) having the symmetric (surface-symmetric) shapes in the left and right direction are used for the pair of relay substrates 34, but the application range of the present invention is not limited to this example. The resin substrates (namely the bases) of the relay substrates 34 may have the same shape.

In addition, in the embodiment described above, a part of the wire stopper 322 protrudes through the opening 341 to the outside of the side face in the X direction of the lens holder 32 from the relay substrate 34, but the application range of the present invention is not limited to this example. The entire wire stopper 322 may protrude through the opening 341 to the outside of the side face in the X direction of the lens holder 32 from the relay substrate 34.

In addition, other than the embodiment described above, the structure of the present invention may be modified variously within the scope of the present invention without deviating from the spirit of thereof. In other words, the embodiment described above is an example in every aspect and should not be interpreted as a limitation. The technical scope of the present invention is defined not by the above description of the embodiment but by the claims, which should be interpreted to include every modification within the claims and the equivalent meanings and scope thereof.

What is claimed is:

1. An actuator comprising:
a movable part; and
a fixed part supporting the movable part in a movable manner, wherein
the movable part includes a case and a plurality of drive substrates having the same specification disposed at positions opposed to each other with respect to the case,
each of the drive substrates includes a winding member for driving the movable part and a wiring pattern for supplying current to the winding member, and
the wiring pattern includes a plurality of electrodes disposed at positions opposed to each other with respect to the winding member, and a conductive path branching from one end of the winding member so as to be connected to the plurality of electrodes.

2. The actuator according to claim 1, further comprising a power supply member for supplying electric power to the movable part, wherein
the case is provided with a relay substrate for electrically connecting between the drive substrates, and a contact prevention member protruding for preventing the power supply member from contacting with the drive substrate, and
at least a part of the contact prevention member protrudes through an opening formed in the relay substrate to the outside of the side face from the relay substrate.

3. The actuator according to claim 1, wherein
the drive substrate is attached to the case using adhesive that is cured by irradiation with ultraviolet rays,
the case is provided with a recess opening on an attachment surface of the case to which the drive substrate is attached and on an adjacent surface to the attachment surface,
the recess includes an inclined part having an inner wall inclined to the adjacent surface, and
the adhesive is filled in the recess.

4. The actuator according to claim 1, wherein
the movable part further includes a plurality of relay substrates for electrically connecting between the drive substrates, and
the relay substrates have shapes that are surface symmetric to each other and have conductive patterns different from each other.

5. An optical pickup comprising the actuator according to claim 1.

6. A disc apparatus comprising the optical pickup according to claim 5.
